(19) United States
(12) Patent Application Publication
(10) Pub. No.: US 2015/0086703 A1
(43) Pub. Date: Mar. 26, 2015

(54) BAKED FRY PROCESS AND PRODUCT

(71) Applicant: H.J. HEINZ COMPANY, Pittsburgh, PA (US)

(72) Inventors: Aaron Jon Bennett, Pittsburgh, PA (US); Craig Howard Doan, Weiser, ID (US); Tamra Jo Dobler, Fruitland, ID (US); Josie Lynn Landon, Caldwell, ID (US); James Elwood Matthews, Wexford, PA (US)

(73) Assignee: H.J. HEINZ COMPANY, Pittsburgh, PA (US)

(21) Appl. No.: 14/391,127

(22) PCT Filed: Feb. 13, 2013
(86) PCT No.: PCT/US2013/025884

§ 371 Date: Oct. 7, 2014

Related U.S. Application Data
(60) Provisional application No. 61/622,750, filed on Apr. 11, 2012.

(51) Int. Cl. A23L 1/217

(52) U.S. Cl. CPC A23L 1/217
USPC 426/637; 426/438

(57) ABSTRACT

A method of making a baked, non-fried, frozen potato product, suitable for final bake processing, which has at least the flavor, exterior crispness, and interior texture of a par-fried product, with lower fat content, without par-flying. The process, among other things, combines warm oil deluge and impingement oven baking.

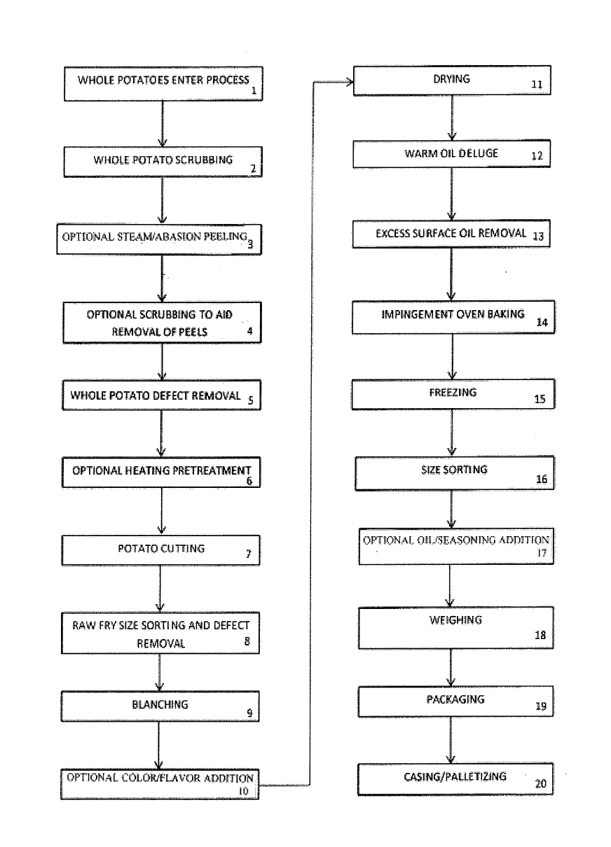

### CROSS-REFERENCE TO RELATED APPLICATIONS

The instant application is a PCT International Application based on U.S. provisional application No. 61/622,750, filed Apr. 11, 2012, the disclosure of which is hereby expressly incorporated by reference hereto in its entirety.

The field of art to which this invention generally pertains is processes for preparing food material and food products produced thereby.

### BACKGROUND

Large volumes of potatoes are consumed worldwide in the form of french fried potatoes. For convenience, the potatoes are typically par-fried and frozen for ease of preparation by the ultimate user (home use) or seller (in the restaurant trade, for example). Although convenient, often this process results in a trade-off in quality, texture, etc. of the resulting product. Also, with the push for healthier foods, the fat content of french fried potatoes has come under greater scrutiny.

While there have been attempts in the past to address some of these issues, note for example, U.S. Pat. Nos. 4,269,861 and 5,393,544, the disclosures of which are herein incorporated by reference, there is a continuing search for a method of preparing french fried potatoes which maintains ease-of-preparation convenience factors, without sacrificing organoleptic properties, and while keeping fat content in mind as well.

### BRIEF SUMMARY OF THE INVENTION

A process for preparing frozen potato pieces to accomplish the above results is described, including cutting whole potatoes into pieces, heating the pieces to remove moisture from the pieces, contacting the pieces with oil heated to a temperature below the boiling point of water for a time sufficient to absorb oil onto and into the surface of the pieces, partially baking the pieces, and freezing the pieces. The thus-prepared frozen potato pieces are suitable for subsequent bake (no-fry) processing, with organoleptic properties (such as flavor, external crispness and interior texture) at least equal to an equivalent par-fried product, with lower fat content.

Embodiments of the invention include the process described above wherein the oil contact and baking is for a time at a temperature sufficient to achieve the flavor, exterior crispness, and interior texture of par-fried pieces of similar size and shape; where the pieces are strips, crinkle cuts, wedges, shoestrings, waffle fries, loops or twirls, or steak fries; the process described above where the heating is performed for a time at a temperature to remove about 5% to about 18% moisture from the pieces (all percentages recited herein are by weight); the process described above where the heating is performed at about 200° F. to about 400° F. for about 5 minutes to about 20 minutes; the process described above where the oil is at a temperature of about 150° F. to about 211° F.; the process described above wherein the pieces are contacted with the oil for about 10 seconds to about 60 seconds; the process described above where the oil contact is by immersion; the process described above where the oil contact is by spraying; the process described above where the baking takes place in an impingement oven; the process described above wherein the impingement oven is a hot air impingement oven; the process described above where the baking is at about 350° F. to about 550° F. for about 1 to about 8 minutes.

Additional embodiments include the process described above including washing the whole potatoes prior to cutting, blanching the potato pieces prior to heating, treating the potato pieces with at least one coloring agent prior to heating, and removing surface oil from the potato strips prior to baking; the process described above where the potatoes are peeled before cutting; the process described above wherein the potatoes are steam peeled; the process described above where the peel is removed by scrubbing; the process described above of where defects are removed from the potatoes before cutting; the process described above where the potatoes are pre-heated before cutting; the process described above where the pre-heating is performed at 130° F. to 145° F. for 20 to 45 minutes; the process described above where the cutting is performed mechanically; the process described above where the cutting is performed with a water knife; the process described above where the blanching is performed at 150° F. to 185° F. for 5 to 20 minutes; the process described above where the coloring agents includes annatto, dextrose, caramel, turmeric and/or paprika; the process described above where the flavoring agent treatment and/or coloring agent treatment is performed at 150° F. to 170° F. for 10 to 60 seconds; the process described above where the surface oil is removed with hot forced air; the process described above where the freezing is performed in an individual quick frozen (IQF) or other spiral freezer or freezing tunnel; the process described above wherein the frozen potato pieces are sorted by size; the process described above where the frozen potato pieces are treated with additional oil and/or seasoning; the process described above where the oil and/or seasoning treatment is in a tumble drum.

Additional embodiments include the frozen, cut potato pieces produced by the processes described above; partially baked, non-fried, frozen potato pieces, suitable for final bake processing, having at least the flavor, exterior crispness, and interior texture after baking of a par-fried product of similar size and shape, with lower fat content, without par-frying; the potato pieces described above, having a crinkle cut shape and having a fat content 0.5% to 3% less than equivalent par-fried crinkle cut pieces; and the potato pieces described above wherein, the oil is absorbed into the surface of the pieces to a depth of not more than 4 millimeters.

These and other objects, aspects, embodiments and features of the invention will become more fully apparent when read in conjunction with the following detailed description.

### BRIEF DESCRIPTION OF THE DRAWINGS

The FIGURE shows a flow chart embodiment for a process according to the present invention.

### DETAILED DESCRIPTION OF THE INVENTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments, with occasional reference to the accompanying drawings. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

As shown in the Figure, whole potatoes are selected to begin the process (1). While any potatoes typically used to make french fried potatoes can be used, Russet Burbank, Ranger Burbank, Russet Norkotah, Alturas, Atlantic, Kennebec, Superior, California Long White, American Giant, Wisconsin Pride, Red Norland, Red Pontiac, Red LaSoda, Yukon Gold, Yellow Finn, Michigold, Carola, Nicola, Delta Gold, All Blue, Purple Peruvian, Purple Viking, Russian Banana, Ruby Crescent, or Sweet Potato varieties including but not limited to

Beauregard, Covington, Evangeline, Diane, and Jewel are typically used. The potatoes are subjected to conventional scrubbing (2) to remove any clinging dirt, dust, etc. While the skins can be left on the potatoes, they can also be removed, again by conventional steam or abrasion peeling methods (3). Also optionally, the potatoes can be conventionally scrubbed to aid in the removal of the peels (4). Any potatoes with obvious defects, e.g. rot or extreme misshape, are either trimmed or sorted out at this point (5). While this can be done optically, it is typically done manually at this stage.

A water/heating pre-treatment can also optionally take place at this time (6) for the purpose of tempering the potatoes prior to cutting. This is typically done at a water temperature of 130° F. to 145° F. for a period of 20 to 45 minutes.

The potatoes are typically cut either mechanically or using a water knife at this time (7). The pieces can be cut into any conventional shape, including but not limited to strips, crinkle cuts, wedges and steak fries. The potatoes are then screened, sorted and graded for length ratio (8). This is typically done using sizing tables or shaker grader tables. Another inspection is also typically performed at this time for defect removal. This is typically done by conventional optical sorting.

Blanching (9) is next performed to remove excess sugars from the french fries. Typically the potatoes are transported to the blanchers by flume. Conventional water blanching usually takes 5 to 20 min. at 150° F. to 185° F.

The potatoes are next optionally treated with one or more coloring and/or flavoring agents (e.g., annatto, dextrose, caramel, turmeric, paprika, etc.) for example, by flume or drag addition (10). This typically takes 10 seconds to a minute, at 150° F. to 170° F.

The treated potatoes are then dried (11) at a temperature for a time period sufficient to remove surface moisture from the potato pieces (e.g., removing blanch water) and to concentrate the total solids in the potato pieces._A preferred time and temperature range is 200° F. to 400° F. for 5 min. to 20 min. At this time and temperature typically 5% to 18% moisture content is removed from the potatoes, depending on the size and shape of the pieces.

It's at this point in the process that the dried potatoes are subjected to the warm oil deluge (12). The amount of oil imparted to the potatoes at this point is controlled to impart the ultimate flavor, exterior crispness and interior texture desired in the final baked, non-fried, french fry product, but with lower fat content than a typical equivalent par-fried, french fry product. The amount of oil imparted onto and into the potato pieces will depend on the size and shape of the particular potato pieces, the variety of potato used, and the initial raw potato total solids. But because the time and temperature of the warm oil deluge is controlled, the amount of fat content in the final potato product is typically 0.5% to 3% below that of the equivalent par-fried potato product, independent of the shape and size. The warm oil deluge is typically performed by spraying or dipping the potato with or in the oil at about 150° F. to about 211° F. (e.g., below the boiling point of water) for 10 seconds to 60 seconds. So while the temperature of the oil is controlled so as to absorb some oil into and onto the potato pieces, the temperature is kept in this range to avoid any frying of the potato pieces. For a crinkle cut potato 9/16 inch by 9/16 inch on a side, under these conditions the oil penetration is typically limited to 4 millimeters or less, resulting in a fat content of less than 3%, and more typically 2.8% or less (see the Tables below). Any excess surface oil can be removed (13) by subjecting the potato pieces to forced hot air to remove excess surface oil. Any commercial forced hot air, oil reclaiming equipment typically used in the food industry can be used for this part of the process.

The oil deluged potatoes are then baked (14) in an impingement oven at a temperature for a time period long enough to achieve at least the exterior crispness, and interior texture of an equivalent par-fried product, after final baking by the ultimate consumer. Typically this is at a temperature range of 350° F. to 550° F. for 1 minute to 8 minutes. Any commercial impingement oven typically used in the food industry can be used for this part of the process such as a conventional hot air impingement oven, for example.

After baking, the baked potato pieces are then frozen (15) for anticipated shipment and storage. A typical IQF tunnel freezer can be used for this part of the process. The potatoes are also typically sorted by size, e.g., in a shaker grader to get the final sizing ratio desired (16).

If additional oil and/or seasoning is desired, they can be optionally added at this time, e.g., utilizing a conventional tumble drum (17).

The processed potatoes are then separated into portions, weighed (18), packaged (19), cased (20), and shipped or stored in typical fashion.

The products produced are partially baked, non-fried, frozen potato pieces. They can be baked before eating, without final fry processing, and provide the flavor, exterior crispness and interior texture equivalent to or better than a par-fried product, with the advantage of lower fat content (final fry-processing is an option if desired, but this would adversely affect the final fat content).

The invention is further illustrated by reference to the following examples. It will be apparent to those skilled in the art that many modifications, both to the materials and methods, may be practiced without departing from the purpose and scope of the invention.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever. For example, while the invention has been described in terms of cut potato pieces, it can be used with conventional extruded potato pieces as well.

### EXAMPLES

Whole potatoes were selected to enter the processing. The potatoes were metered to the line, followed by scrubbing and steam peeling (which is an optional step). The potatoes were next scrubbed to remove the peel (again, another optional step). Potatoes with defects were then removed or trimmed and sorted by manual inspection. The whole potatoes were then pretreated in water at 130° F. to 145° F. for a period of 20 to 45 min. (again an optional step) prior to cutting. The whole potatoes were then cut into crinkle shaped pieces either mechanically or using a water knife to a typical 9/16 inch by 9/16 inch on a side. The cut raw potatoes were then graded using a shaker grader table, screening and sorting for length ratio, and defect removal by optical sorting. The potatoes were then transported by flume to the blanchers. Water blanching was then undertaken for five to 20 min. at 150° F. to 185° F. to remove excess sugars. The potatoes were then subjected to flume or drag addition of annatto, dextrose and/or flavors at 150° F. to 170° F. for 10 seconds to 60 seconds. The treated potatoes were then dried at 200° F. to 400° F. for 5 min. to 20 min. to remove 5% to 18% moisture. The dried potatoes were then subjected to a warm oil deluge by spraying or dipping at 150° F. to 211° F. (for the crinkle cut pieces described above, 200° F. was used) for 10 seconds to 60 seconds (40 seconds for the crinkle cut pieces described above). Excess surface oil is then removed by subjecting the potato pieces to forced hot air to remove excess oil. The potatoes are then baked in an impingement oven at a temperature for a time long enough, e.g., at 350° F. to 550° F. for 1 minute to 8 minutes, to achieve at least the exterior crispness and interior texture of an equivalent par-fried product. The baked potato pieces are then frozen by passing them through an IQF tunnel or spiral freezer. The potatoes are next sorted by size, in a shaker grader to get the final sizing ratio desired. If additional oil and/or seasoning is desired at this time, optionally such ingredients can be added to the process in a tumble drum. And finally, the portions are weighed, packaged, cased and palletized.

The data indicate that par-frying at higher temperatures is not required in order to increase total solids, but rather, the combination of warm oil deluge and impingement oven baking can be used to achieve comparable results with lower fat content. The percent total solids (which will vary depending on the size and shape of the potato pieces, the variety of potato used, and the initial raw potato total solids) is controlled throughout the process, to at least duplicate the properties of the equivalent par-fried product, without the frying. As described in further detail below, this helps in at least duplicating the exterior crispness and texture of the final baked product, for example, without frying and results in lower fat content compared to the equivalent par-fried pieces.

TABLE 1

| | Impingement | | | |
|---|---|---|---|---|
| | Oven | Dwell | | |
| | Temperature | Time | % Total | |
| Test | (° F.) | (minutes) | Solids | % Fat |
| 1 | 350 to 400 | 3.0 | 27.9 | 2.6 |
| 2 | 350 to 400 | 3.5 | 27.7 | 2.4 |
| 3 | 350 to 400 | 4.0 | 28.6 | 2.8 |
| 4 | 350 to 400 | 4.5 | 30.6 | 2.5 |
| 5 | 350 to 400 | 5.0 | 29.2 | 2.7 |

TABLE 2

| | Impingement | | | |
|---|---|---|---|---|
| | Oven | Dwell | | |
| | Temperature | Time | % Total | |
| Test | (° F.) | (minutes) | Solids | % Fat |
| 6 | 375 to 425 | 3.0 | 26.9 | 2.3 |
| 7 | 375 to 425 | 3.5 | 29.3 | 2.6 |
| 8 | 375 to 425 | 4.0 | 30.9 | 2.5 |
| 9 | 375 to 425 | 4.5 | 27.6 | 2.3 |
| 10 | 375 to 425 | 5.0 | 28.3 | 2.3 |

TABLE 3

| | Impingement | | | |
|---|---|---|---|---|
| | Oven | Dwell | | |
| | Temperature | Time | % Total | |
| Test | (° F.) | (minutes) | Solids | % Fat |
| 11 | 400 to 450 | 3.0 | 28.4 | 2.3 |
| 12 | 400 to 450 | 3.5 | 27.5 | 2.6 |
| 13 | 400 to 450 | 4.0 | 30.2 | 2.5 |
| 14 | 400 to 450 | 4.5 | 30.3 | 2.5 |
| 15 | 400 to 450 | 5.0 | 31.0 | 2.7 |

Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A process for preparing frozen potato pieces comprising,
cutting whole potatoes into pieces,
heating the pieces to remove moisture from the pieces,
contacting the pieces with oil heated to a temperature below the boiling point of water for a time sufficient to absorb oil onto and into the surface of the pieces,
partially baking the pieces,
and freezing the pieces.

2. The process of claim 1 wherein the oil contact and baking is for a time at a temperature sufficient to achieve the flavor, exterior crispness, and interior texture of par-fried pieces of similar size and shape.

3. The process of claim 1 wherein,
the pieces are strips, crinkle cuts, wedges, shoestrings, waffle fries, loops or twirls,or steak fries.

4. The process of claim 1 wherein,
the heating is performed for a time at a temperature to remove about 5% to about 18% by weight moisture from the pieces.

5. The process of claim 1 wherein,
the heating is performed at about 200° F. to about 400° F. for about 5 to about 20 minutes.

6. The process of claim 1 wherein,
the oil is at a temperature of about 150° F. to about 211° F.

7. The process of claim 6 wherein the pieces are contacted with the oil for about 10 seconds to about 60 seconds.

8. The process of claim 7 wherein the contact is by immersion.

9. The process of claim 7 wherein the contact is by spraying.

10. The process of claim 1 wherein,
the baking is performed in an impingement oven.

11. The process of claim 10 wherein the impingement oven is a hot air impingement oven.

12. The process of claim 11 wherein the baking is at 350° F. to 550° F. for 1 to 8 minutes.

13. The process of claim 1 including,
washing the whole potatoes prior to cutting,
blanching the potato pieces prior to heating,
treating the potato pieces with at least one coloring and/or flavoring agent prior to heating,
and removing surface oil from the potato strips prior to baking.

14. The process of claim 13 wherein the potatoes are peeled before cutting.

15. The process of claim 14 wherein the potatoes are steam peeled.

16. The process of claim 14 wherein the peel is removed by scrubbing.

17. The process of claim 13 wherein defects are removed from the potatoes before cutting.

18. The process of claim 13 wherein the potatoes are pre-heated before cutting.

19. The process of claim 18 wherein the pre-heating is performed at 130° F. to 145° F. for 20 to 45 minutes.

20. The process of claim 1 wherein the cutting is performed mechanically.

21. The process of claim 1 wherein the cutting is performed with a water knife.

22. The process of claim 13 wherein the blanching is performed at 150° F. to 185° F. for 5 to 20 minutes.

23. The process of claim 13 wherein the coloring and/or flavoring agents include at least one of annatto, dextrose, caramel, turmeric and/or paprika.

24. The process of claim 23 wherein the coloring and/or flavoring agent treatment is performed at 150° F. to 170° F. for 10 to 60 seconds.

25. The process of claim 1 wherein oil on the surface of the pieces is removed with hot forced air.

26. The process of claim 1 wherein the freezing is performed in an individual quick frozen freezer, spiral freezer or freezing tunnel.

27. The process of claim 1 wherein the frozen potato pieces are sorted by size.

28. The process of claim 1 wherein the frozen potato pieces are treated with additional oil and/or seasoning.

29. The process of claim 28 wherein the treatment is in a tumble drum.

30. The frozen, cut potato pieces produced by the process of claim 1.

31. Partially baked, non-fried, frozen potato pieces, suitable for final bake processing, having at least the flavor, exterior crispness, and interior texture after baking of a par-fried product of similar size and shape, with lower fat content, without par-frying.

32. The potato pieces of claim 31, having a crinkle cut shape and having a fat content 0.5% to 3% less than equivalent par-fried crinkle cut pieces.

33. The potato pieces of claim 31 wherein,
the oil is absorbed into the surface of the pieces to a depth of not more than 4 millimeters.
